(19) United States
(12) Patent Application Publication
(10) Pub. No.: US 2010/0083686 A1
(43) Pub. Date: Apr. 8, 2010

(54) APPARATUS FOR DISPENSING BEVERAGES THROUGH A REFRIGERATOR DOOR

(76) Inventors: Mathiew T. Reels, Cookeville, TN (US); Teresa Everard, Baxter, TN (US)

Correspondence Address: Russ Weinzimmer, 614 Nashua Street, Suite 53, Milford, NH, 03055, US

(21) Appl. No.: 12/245,719

(22) Filed: Oct. 4, 2008

(51) Int. Cl. B67D 5/62; B67D 5/06; B67D 5/00

(52) U.S. Cl. 62/390; 222/144.5; 222/146.6; 222/185.1; 222/1

(57) ABSTRACT

A beverage dispensing apparatus is disclosed that can select and dispense a beverage from any of a plurality of standard beverage containers mounted behind a closed refrigerator door. The apparatus includes adapter caps that preserve beverage qualities such as carbonation by sealing the containers in lieu of standard caps. The containers are inverted and the adaptor caps are coupled to female receptacles that open valves in the caps, thereby gaining access to the beverages. A beverage selector controlled from outside of the refrigerator selects a beverage, which flows to an external dispenser through a single conduit that penetrates the door. Embodiments include a container supporting structure which can include orifices and tabs that stabilize containers in the orifices. Some embodiments can support and select between three standard, two-liter soda bottles. Preferred adapter caps include air inlets that allow air to displace dispensed beverage. Embodiments can be retrofitted to standard refrigerators.

### FIELD OF THE INVENTION

The present invention relates generally to beverage dispensers, and more particularly to devices that permit the dispensing of beverages through a closed refrigerator door.

### BACKGROUND OF THE INVENTION

Refrigerators are often used to store beverages so as to keep them cool and ready to consume. Normally, the door of the refrigerator must be opened and a soda or other beverage container must be located and removed for consumption. This causes a significant loss of cold air from the interior of the refrigerator while the door is open and the beverage container is being located, and a consequent waste of energy. Often, sodas and other beverages are stored in a refrigerator in containers that hold more than one serving, such that the refrigerator door must be opened repeatedly so as to obtain and return a container on multiple occasions until the entire contents of the container have been consumed. In the case of sodas and other carbonated beverages, an added disadvantage of this approach is that the pressure within the container must be released each time the multiple-serving container is opened, thereby reducing the carbonation of the remaining beverage in the container.

One approach that can improve convenience and reduce energy waste is to include a drink dispenser in the door of a refrigerator, so as to allow dispensing of a beverage without opening the refrigerator door. A refrigerator door that contains a drink dispenser is known. An example of such a dispenser is disclosed in U.S. Pat. No. 4,610,375, entitled REFRIGERATOR DOOR WITH DRINK DISPENSER, issued on Sep. 9, 1986 to Germi et al. The Germi device utilizes a special beverage container that must be filled and refilled from some external source, such as a container or a pipe connected to a source that is external to the refrigerator.

A dispenser that includes a removable pitcher is disclosed in U.S. Pat. No. 3,934,758, entitled REFRIGERATOR BEVERAGE DISPENSER-MIXER, issued on Jan. 27, 1976 to Kipp. The pitcher fits within a specially formed receptacle that occupies a substantial portion of the refrigerator door surface and cross sectional area. The pitcher must be filled with a beverage from some external source prior to use.

Another dispenser that occupies a relatively large area of the refrigerator door is disclosed in U.S. Pat. No. 4,930,666, entitled JUICE DISPENSING SYSTEM FOR A REFRIGERATOR DOOR, issued to Rudick. In this arrangement, the beverage container must be located directly over a spigot that is aligned with a serving receptacle, thereby necessitating that a large cavity be formed within the refrigerator door during manufacture.

A similar arrangement is shown in U.S. Pat. No. 5,791,517, entitled BEVERAGE DISPENSING DEVICE, issued on Aug. 11, 1998 to Avital. The Avital device is further burdened by an elaborate vent structure which must be inserted into the beverage container each time the container is replaced.

Another vertically aligned system is disclosed in U.S. patent application Ser. No. 11/183,549, entitled REFRIGERATOR MOUNTED HOT BEVERAGE DISPENSER, filed by Bordino Jul. 29, 2005. The Bordino system utilizes numerous electronic components to select and control the dispensing of each beverage.

A final example of a vertically aligned system is depicted in U.S. Pat. No. 7,337,924, entitled REFRIGERATOR WHICH REMOVABLY HOLDS A DRINK SUPPLY CONTAINER HAVING A VALVE CO-ACTING WITH AN ENGAGER, issued on Mar. 4, 2008 to Crisp et al. The drink supply in this device is accessed through hinged doors placed on the front of the refrigerator during manufacture, the entire system occupying approximately 25% of the refrigerator door surface area.

A refrigerator dedicated exclusively to beverage storage and dispensing is disclosed in U.S. Pat. No. 5,064,097, entitled COMPACT WATER PURIFICATION AND BEVERAGE DISPENSING APPARATUS, issued on Nov. 12, 1991 to Brog et al. This device requires substantial additional floor space in addition to any other refrigerator used for normal household food storage purposes.

U.S. Pat. No. 5,096,095, entitled DOOR BEVERAGE DISPENSER, issued on Mar. 17, 1992 to Burton discloses the use of a refillable container that is located below the beverage dispensing spigot. This arrangement requires a source of pressurization to force the beverage to the dispenser as well as the use of a check valve to prevent leakage.

Each of the aforementioned devices is relatively complex, and all suffer from an inability to be retrofitted to an existing refrigerator. The expense of each of these known systems is substantial, and they typically use customized containers that must be periodically refilled, often degrading the qualities of a beverage, especially if the beverage is carbonated. Finally, the labor needed to constantly refill rather than replace each of the dedicated beverage containers is significant, as is the continuing storage requirement for the original beverage containers which must be kept readily available.

### SUMMARY OF THE INVENTION

The present invention addresses the shortcomings of previous refrigerator door type beverage dispensers that either necessitate or encourage the use of a dedicated beverage container that must be frequently refilled or which require substantial amounts of refrigerator door cross section for proper operation. The present invention is an apparatus adapted to secure within a refrigerator multiple standardized beverage containers (two liter soda containers in preferred embodiments) which may be easily inserted and removed therefrom. The apparatus is mounted inside the refrigerator in a substantially abutting relationship with the interior wall of the refrigerator door. The beverage containers are exposed to the interior of the refrigerator and are therefore kept at substantially the same temperature as the other contents of the refrigerator.

More particularly, the apparatus of the present invention includes a plurality of female receptacles, each female receptacle being formed to include a pipe or conduit that connects to a beverage selector controlled by a multi-position knob or other beverage selector control that can be controlled from the exterior side of the refrigerator door. A single conduit then passes from the beverage selector through the refrigerator door and terminates in a faucet or dispensing head that may be opened by pushing a button, moving a lever, or activating a similar control. The dispensing head may be placed in a cutout or recessed region already present in the refrigerator door due to the presence of a water and ice dispenser, or the dispenser may extend beyond the plane of the door and be protected by a small hood or cover. In either case, the apparatus may be included in a newly manufactured refrigerator or it may be retrofitted to an existing refrigerator.

Each beverage container is fitted with an adapter cap which includes a cap valve that seals the beverage container. The adapter cap is inserted into a female receptacle that opens the cap valve and creates a continuous path for liquid to flow between the beverage container and the beverage selector. A single fluid conduit then traverses a space within the refrigerator door and delivers a selected beverage to a dispenser external mounted on the external side of the refrigerator door.

The present invention minimizes energy loss and maximizes convenience by allowing multiple beverages to be selected while the refrigerator door remains shut and only one fluid conduit traverses the space within the refrigerator door. Also, an adapter cap needs to be fitted to each beverage container only once, thereby preserving the integrity of the container contents, including its carbonation if the beverage is carbonated. By labeling each container retaining position of the apparatus, and by providing corresponding labels cooperative with the beverage selector, a user of the present invention is able to select a desired beverage without opening the refrigerator door.

One general aspect of the invention is an apparatus for dispensing beverages through a refrigerator door from a plurality of standard beverage containers. The apparatus includes the following elements:

a plurality of adapter caps capable of sealing the beverage containers;

a plurality of female receptacles cooperative with an inner side of the refrigerator door and able to couple to the adapter caps when the adapter caps are sealing inverted beverage containers, thereby opening cap valves in the adapter caps and gaining access to beverages contained in the beverage containers;

a beverage selector that enables a user to select a beverage from any of the female receptacles when the refrigerator door is closed; and

a beverage dispenser in fluid communication with the beverage selector through a conduit that traverses a space within the refrigerator door, the beverage dispenser being able to dispense the selected beverage when the refrigerator door is shut.

In preferred embodiments, the apparatus further includes a beverage container supporting structure that is able to align a beverage container with one of the female receptacles. In some of these embodiments the supporting structure includes at least one vertical support adapted to align the beverage container with the female receptacle. In other of these embodiments the supporting structure is able to at least partly support the weight of a beverage container attached to the female receptacle.

In various embodiments that include a supporting structure the supporting structure includes an orifice that is able to align a beverage container with a female receptacle when the beverage container is inserted through the orifice. Some of these embodiments further include a tab that protrudes inwardly from a perimeter of the orifice so as to assist in securing a beverage container residing within the orifice. in some of these embodiments the tab is composed of a resilient material, and other of these embodiments include a plurality of tabs protruding inwardly from the perimeter of the orifice.

In various preferred embodiments the beverage selector includes a selector control that is accessible to a user when the refrigerator door is closed, the selector control being one of a rotary knob and a multi-selection switch.

In some preferred embodiments the beverage dispenser is activated by operating a dispenser control that is accessible to a user when the refrigerator door is closed, the dispenser control being one of a button, a knob, and a lever. In other preferred embodiments the apparatus is able to dispense a beverage contained in a standard two liter soda container. And in various preferred embodiments the apparatus is configured so that it can be retrofit to a standard refrigerator door.

In certain preferred embodiments the adapter cap includes an air inlet that allows displacing air to enter a beverage container as beverage is dispensed from the beverage container.

Another general aspect of the invention is an apparatus for dispensing beverages through a refrigerator door. The apparatus includes the following elements:

a supporting structure attached to an inside surface of the refrigerator door, the supporting structure being able to retain three standard beverage containers in an inverted orientation;

three adapter caps capable of sealing the three standard beverage containers;

three female receptacles cooperative with the supporting structure and able to couple to the adapter caps when the adapter caps are sealing inverted beverage containers, thereby opening cap valves in the adapter caps and gaining access to beverages contained in the beverage containers;

a beverage selector that enables a user to select a beverage from any of the female receptacles when the refrigerator door is closed; and

a beverage dispenser in fluid communication with the beverage selector through a conduit that traverses a space within the refrigerator door, the beverage dispenser being able to dispense the selected beverage when the refrigerator door is shut.

In preferred embodiments the supporting structure includes three container receiving orifices, each container receiving orifice being adapted to receive a vertically aligned beverage container. In some preferred embodiments the apparatus further comprises a plurality of vertical beverage retaining supports, each vertical beverage retaining support being adapted to vertically abut a portion of a beverage container, and a plurality of resilient tabs, each tab protruding inwardly from a perimeter of an orifice.

Yet another general aspect of the invention is a method of dispensing a beverage through a refrigerator door. The method includes the following steps:

Providing an apparatus that includes a plurality of adapter caps capable of sealing the beverage containers, a plurality of female receptacles cooperative with an inner side of the refrigerator door and able to couple to the adapter caps when the adapter caps are sealing inverted beverage containers, thereby opening cap valves in the adapter caps and gaining access to beverages contained in the beverage containers, a beverage selector that enables a user to select a beverage from any of the female receptacles when the refrigerator door is closed, and a beverage dispenser in fluid communication with the beverage selector through a conduit that traverses a space within the refrigerator door, the beverage dispenser being able to dispense the selected beverage when the refrigerator door is shut;

sealing a standard beverage containers with an adapter cap;

aligning the male adapter cap with the female receptacle;

advancing the adapter cap into the female receptacle so as to open the cap valve in the adapter cap and form a fluid tight seal between the beverage container and the female receptacle;

closing the refrigerator door;

selecting the beverage container using the beverage selector; and
dispensing a beverage contained within the beverage container through the beverage dispenser.

### BRIEF DESCRIPTION OF THE DRAWINGS

FIG. 1 is an isometric view of an apparatus built in accordance with the principles of the present invention, including a cut away portion, and also depicting beverage containers aligned with, but not inserted into, the apparatus;

FIG. 2 is an isometric view of the apparatus depicted in FIG. 1 with some components removed for clarity, with two cut away portions included, and shown mounted inside a refrigerator door;

FIG. 3 is a top plan view of a portion of the apparatus depicted in FIG. 1;

FIG. 4 is an isometric view of the female receptacle illustrated in FIG. 2 used for coupling a beverage container to a beverage dispenser;

FIG. 5 is a schematic view of the female receptacle depicted in FIG. 2 when coupled to the adapter cap depicted in FIG. 1; and

FIG. 6 is an isometric view of the apparatus depicted in FIG. 1 shown mounted to a refrigerator door.

### DETAILED DESCRIPTION OF THE INVENTION

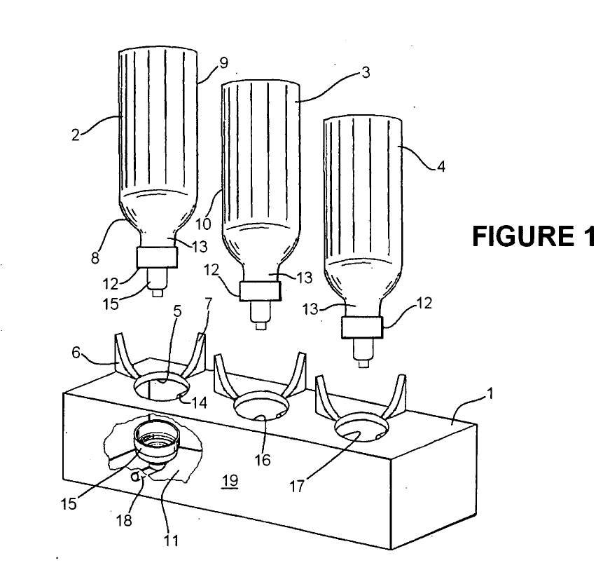

FIG. 1 illustrates a supporting structure 1 for the standard beverage containers 2, 3 and 4. In the preferred embodiment of FIG. 1, the supporting structure is made from molded plastic, while in other preferred embodiments the standard beverage containers are supported by a plurality of metal brackets or by other supporting devices. In certain preferred embodiments the supporting structure is omitted, and the standard beverage containers are supported directly by the female receptacles 15 to which they are coupled. The standard beverage containers are typically plastic, two-liter soft drink containers, but the supporting structure 1 may be constructed and suitably dimensioned to accept any standard beverage container sizes and shapes.

The supporting structure 1 includes a first container receiving orifice 5 which is adapted to receive the standard beverage container 2. Adjacent to the first container receiving orifice 5 is a first container vertical support 6 and a second container vertical support 7, the container vertical supports 6 and 7 being suitably shaped and dimensioned to receive the curved sides 8 of the container 2 in a substantially abutting relationship. A resilient tab or bumper 14 may also be placed such that it protrudes inward from the perimeter of the orifice 5, thereby tending to abut and grip the container 2 so as to prevent slippage or tilting of the container once the container 2 is placed within the orifice 5. A greater or lesser number of vertical supports 6 and 7, as well as bumpers 14, may be used in association with the orifice 5 so as to adequately retain the container 2. In the case of a container 2 having a substantially continuous vertical side portion 9, the vertical side 10 of the adjacent standard beverage container 3 may be sufficient to support the container 2 without the need of either vertical support 6 or 7.

While three standard beverage containers 2, 3 and 4 are depicted in FIG. 1, in various embodiments the apparatus 1 is constructed to accommodate either a greater or lesser number of standard beverage containers, as well as to accommodate containers which are not substantially identical in size and shape, in which case the vertical supports 6 and 7 may differ in size, shape and placement.

Each standard beverage container 2, 3 and 4 is typically purchased with a removable, threaded cap. Regardless of the type of cap used, the original cap is removed and an adapter cap 12 is fitted to each container 2, 3 and 4 in its place, typically by threading the adapter cap 12 onto the pre-existing threads formed by the manufacturer of the container at the neck 13 of each container. The adapter cap 12 includes a cap valve (not shown) that seals the standard beverage container 2,3, and 4 when the adapter cap is not coupled to a female receptacle 15, thereby preserving the qualities of the standard beverage, including the carbonation if the standard beverage is carbonated. The adapter cap 12 also includes an extension 23 through which the standard beverage within the container 2, 3 and 4 may be dispensed. In some embodiments that dispense carbonated beverages, gas resulting from the carbonation displaces liquid dispensed from the standard beverage container 2, 3, and 4, while in other embodiments the adapter cap 12 includes an air inlet extension through which displacing air can be introduced into the container 15 as beverage is dispensed.

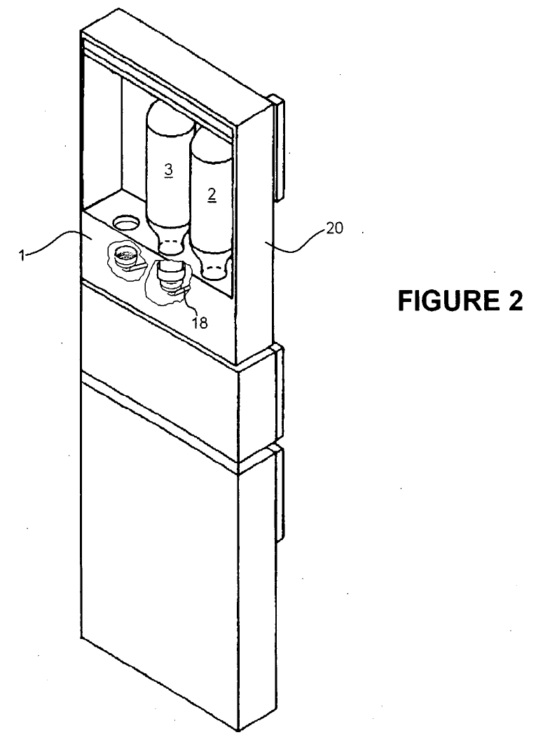

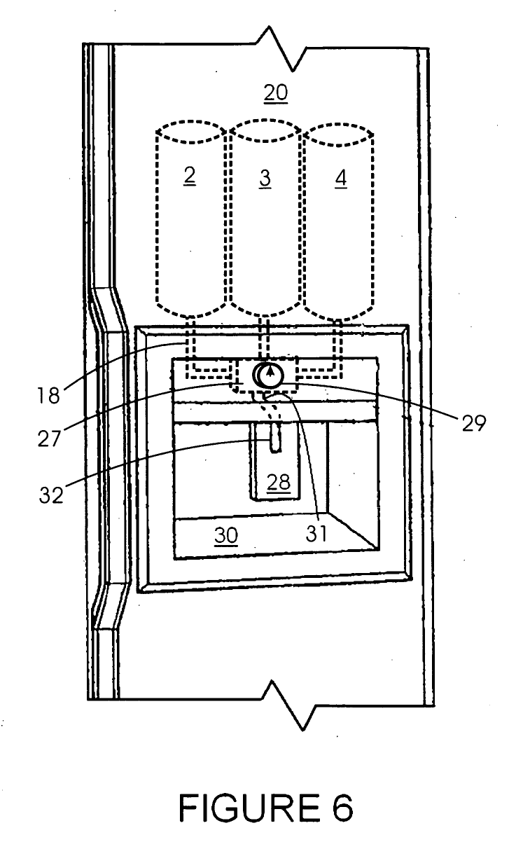

Mounted within an interior region 11 of the supporting structure 1 is a plurality of female receptacles 15, each female receptacle 15 being placed beneath and substantially aligned with each container receiving orifice 5, 16 and 17. In embodiments that do not include a supporting structure, the female receptacles 15 are mounted directly to the inner side of the refrigerator door (20 in FIG. 2, discussed in more detail below). Each female receptacle 15 includes a conduit 18 that connects to a beverage selector (27 in FIG. 6, discussed in more detail below). When then adapter 12 and the receptacle 15 are interconnected, the contents of the container 2 are free to flow into the conduit 18.

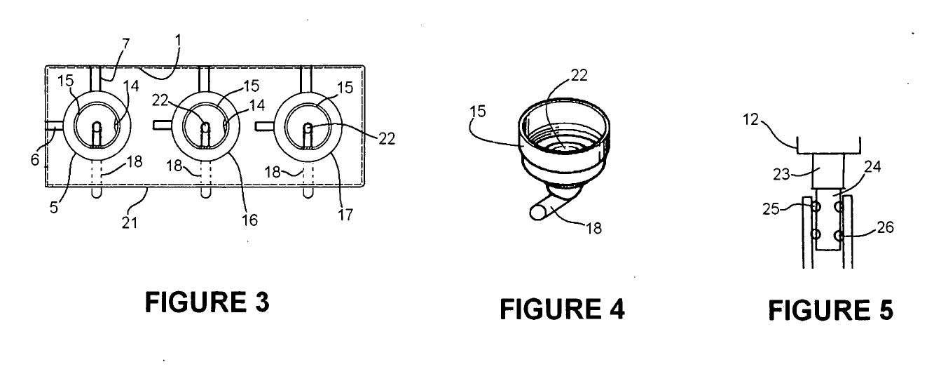

Referring also to FIGS. 2 and 3, the mounting of the supporting structure 1 onto a refrigerator door 20 can be appreciated. The apparatus 1 is mounted at a location where the conduits 18 have an unobstructed path to a beverage selector (not shown) mounted to an interior region of the door 20. The supporting structure 1 may be integrally formed or mounted as part of the door 20 during manufacture of the refrigerator, or it may be retrofitted to an existing door after the refrigerator has been installed at a retailer or customer location.

Referring also to FIGS. 3 and 4, the female receptacle 15 is formed to include a channel 22. The channel 22 is in fluid communication with the conduit 18. As is best seen in FIG. 5, the channel 22 receives a tip region 24 of the adapter cap 23 to open the cap valve and provide an uninterrupted fluid path. A pair of o-rings 25 and 26 can be fitted to the tip region 24 of the adapter cap 23 so as to prevent leakage of the beverage as it passes from the container 2 into the conduit 18.

As may be seen in FIG. 6, the conduits 18 from the female receptacles 15 all lead to a beverage selector 27 located behind the refrigerator door 20. A knob 28 mounted on the front surface of the refrigerator door 20 connects by a shaft (not shown) to the beverage selector 27, thereby allowing a user to select one of the beverages 2, 3, 4 while the refrigerator door 20 is closed. In similar embodiments a switch mounted to the front surface of the refrigerator door communicates with an electronically controlled beverage selector using wires that traverse a space within the refrigerator door. A single dispenser conduit 31 passes through the refrigerator door 20 and terminates at a beverage dispenser 32. In preferred embodiments, the beverage dispenser 32 is activated by pushing a button or moving a lever 28. The beverage selection knob 28 can include a pointer and/or labels, which indicate the selection positions of the knob 28 and/or the contents of the beverage containers 2, 3, 4. A recessed area 30 may optionally be formed within the door 20 to prevent spillage on the floor area surrounding the refrigerator.

From the foregoing one can readily foresee that numerous modifications to the may be made without departing from the spirit and the scope of the invention. For example, the dimensions of the apparatus 1 may be varied depending on the type and size of the both the beverage containers and the refrigerator door. The adapter caps 12 may be modified as desired to either surround or secure a beverage container differing from the beverage containers 2, 3 and 4 described herein. The positions of the various orifices and conduits defining the pathways to the dispenser 32 may be modified as desired to support various embodiments of beverage containers and refrigerator doors.

Accordingly, other modifications and implementations will occur to those skilled in the art without departing from the spirit and the scope of the invention as claimed, and the above description is not intended to limit the invention except as indicated in the following claims.

What is claimed is:

1. An apparatus for dispensing beverages through a refrigerator door from a plurality of standard beverage containers, the apparatus comprising:
a plurality of adapter caps capable of sealing the beverage containers;
a plurality of female receptacles cooperative with an inner side of the refrigerator door and able to couple to the adapter caps when the adapter caps are sealing inverted beverage containers, thereby opening cap valves in the adapter caps and gaining access to beverages contained in the beverage containers;
a beverage selector that enables a user to select a beverage from any of the female receptacles when the refrigerator door is closed; and
a beverage dispenser in fluid communication with the beverage selector through a conduit that traverses a space within the refrigerator door, the beverage dispenser being able to dispense the selected beverage when the refrigerator door is shut.

2. The apparatus of claim 1, further comprising a beverage container supporting structure that is able to align a beverage container with one of the female receptacles.

3. The apparatus of claim 2, wherein the supporting structure includes at least one vertical support adapted to align the beverage container with the female receptacle.

4. The apparatus of claim 2, wherein the supporting structure is able to at least partly support the weight of a beverage container attached to the female receptacle.

5. The apparatus of claim 2, wherein the supporting structure includes an orifice that is able to align a beverage container with a female receptacle when the beverage container is inserted through the orifice.

6. The apparatus of claim 5, further comprising a tab, the tab protruding inwardly from a perimeter of the orifice so as to assist in securing a beverage container residing within the orifice.

7. The apparatus of claim 6, wherein the tab is composed of a resilient material.

8. The apparatus of claim 6, further comprising a plurality of tabs protruding inwardly from the perimeter of the orifice.

9. The apparatus of claim 1, wherein the beverage selector includes a selector control that is accessible to a user when the refrigerator door is closed, the selector control being one of a rotary knob and a multi-selection switch.

10. The apparatus of claim 1, wherein the beverage dispenser is activated by operating a dispenser control that is accessible to a user when the refrigerator door is closed, the dispenser control being one of a button, a knob, and a lever.

11. The apparatus of claim 1, wherein the apparatus is able to dispense a beverage contained in a standard two liter soda container.

12. The apparatus of claim 1, wherein the apparatus is configured so that it can be retrofit to a standard refrigerator door.

13. The apparatus of claim 1, wherein the adapter cap includes an air inlet that allows displacing air to enter a beverage container as beverage is dispensed from the beverage container.

14. An apparatus for dispensing beverages through a refrigerator door, the apparatus comprising:
a supporting structure attached to an inside surface of the refrigerator door, the supporting structure being able to retain three standard beverage containers in an inverted orientation;
three adapter caps capable of sealing the three standard beverage containers;
three female receptacles cooperative with the supporting structure and able to couple to the adapter caps when the adapter caps are sealing inverted beverage containers, thereby opening cap valves in the adapter caps and gaining access to beverages contained in the beverage containers;
a beverage selector that enables a user to select a beverage from any of the female receptacles when the refrigerator door is closed; and
a beverage dispenser in fluid communication with the beverage selector through a conduit that traverses a space within the refrigerator door, the beverage dispenser being able to dispense the selected beverage when the refrigerator door is shut.

15. The beverage dispensing system of claim 14, wherein the supporting structure includes three container receiving orifices, each container receiving orifice being adapted to receive a vertically aligned beverage container.

16. The beverage dispensing system of claim 15, wherein the apparatus further comprises:
a plurality of vertical beverage retaining supports, each vertical beverage retaining support being adapted to vertically abut a portion of a beverage container; and
a plurality of resilient tabs, each tab protruding inwardly from a perimeter of an orifice.

17. A method of dispensing a beverage through a refrigerator door, the method comprising the steps of:
Providing an apparatus that includes a plurality of adapter caps capable of sealing the beverage containers, a plurality of female receptacles cooperative with an inner side of the refrigerator door and able to couple to the adapter caps when the adapter caps are sealing inverted beverage containers, thereby opening cap valves in the adapter caps and gaining access to beverages contained in the beverage containers, a beverage selector that enables a user to select a beverage from any of the female receptacles when the refrigerator door is closed, and a beverage dispenser in fluid communication with the beverage selector through a conduit that traverses a space within the refrigerator door, the beverage dispenser being able to dispense the selected beverage when the refrigerator door is shut;
sealing a standard beverage containers with an adapter cap;
aligning the male adapter cap with the female receptacle;
advancing the adapter cap into the female receptacle so as to open the cap valve in the adapter cap and form a fluid tight seal between the beverage container and the female receptacle;
closing the refrigerator door;
selecting the beverage container using the beverage selector; and
dispensing a beverage contained within the beverage container through the beverage dispenser.
